(19) United States
(12) Patent Application Publication
(10) Pub. No.: US 2017/0147715 A1
(43) Pub. Date: May 25, 2017

(54) DESIGN SUPPORT DEVICE, METHOD, AND PROGRAM RECORD MEDIUM

(71) Applicant: NEC Corporation, Minato-ku, Tokyo (JP)

(72) Inventor: Sayaka IZUKURA, Tokyo (JP)

(73) Assignee: NEC Corporation, Minato-ku, Tokyo (JP)

(21) Appl. No.: 15/129,603

(22) PCT Filed: Apr. 17, 2015
(86) PCT No.: PCT/JP2015/002120

§ 371 Date: Sep. 27, 2016

(30) Foreign Application Priority Data
Apr. 23, 2014 (JP) 2014-089098

(51) Int. Cl. G06F 17/50

(52) U.S. Cl. CPC G06F 17/504; G06F 2217/06

(57) ABSTRACT

There is disclosed a design support device with which it is possible to automatically and effectively derive a candidate for a system configuration that satisfies specified non-functional requirements, while taking into account various factors affecting the non-functional requirements. Said design support device is provided with: a reception unit configured to receive non-functional requirements; and a constraint condition generating unit configured to generate, in regard to attribute values for the components of a system designed by combining two or more types of components, constraint conditions for the attribute values for satisfying the non-functional requirements received by the reception unit to be generated on the basis of attribute-value condition information that defines conditions required to satisfy the non-functional requirements.

### TECHNICAL FIELD

The present invention relates to a design support device, a method, and a program recording medium which support design of a computer system.

### BACKGROUND ART

In development of a computer system (hereinafter, referred to as “system”), system design (architecture) has to be determined so that various requirements specified by a client are satisfied.

The various requirements specified by a client includes quality of the system (QoS: Quality of Service). One of indices representing quality of the system is a requirement (non-functional requirement) on non-function like performance, availability, or the like.

The non-functional requirement is determined based on a content of “Non-functional requirement grade table” or ITIL (Information Technology Infrastructure Library) which define an evaluation item and a level of a service level which a development target system has to satisfy for each of system sizes or each degree of social influence, by levels with several stages.

However, since the quality of the system is affected from various design parameters on a configuration of HW (Hardware), a setting item of MW (Middleware), or the like, and a plurality of combinations of design parameters satisfying non-functional requirements exist, appropriate design requires advanced knowledge.

Therefore, a design support device which automatically and efficiently derives the combinations of design parameters satisfying the non-functional requirements is needed.

As relevant technologies, Patent literature 1 discloses the technology related to system design of SOA (Service Oriented Architecture) made by associating with a Web service. In the technology described in Patent literature 1, processing which can achieve specified non-functional requirements is given to each Web service while considering probability of installing in a software (middleware) product to be used and priority of the non-functional requirements. Thereby an appropriate combination of Web services can be determined.

Patent literature 2 discloses the technology in which values such as mean processing time (performance value) which affect non-functional requirements of the whole system are registered, in advance, for a Web service, and design is performed while extracting a service which satisfies specified requirements or is close to the specified requirements.

Patent literature 3 discloses the technology in which setting values to be satisfied are received from a user in order of importance of a requirement and a proper combination of system components (product) is determined. In the technology described in Patent literature 3, system components corresponding to setting values received from a user are extracted in order, and a candidate of a combination which is consistent with a configuration extracted with respect to the setting value with high-ranking requirement is acquired and presented to a user.

Patent literature 4 discloses the device which can readily specifies setting items which have to be reviewed in order to satisfy SLO (Service Level Objective). The device specifies SLO which may be affected (requirement may not be satisfied) when a value of a setting item is changed and specifies a setting item whose setting value has to be reviewed in order to satisfy the SLO, based on correspondence relation between a setting item of a business system and the SLO.

Patent literature 5 discloses the interactive design support device which determines the optimum system configuration. The design support device stores, as know-how, information which is necessary for system construction, like a model systemizing a system configuration, network configuration which is available for each model, or processing ability of a server. The design support device determines the optimum system by receiving a choice of conditions from a user through a pull-down menu.

### CITATION LIST

### Patent Literature

PTL 1: Japanese Patent Publication No. 5049911

PTL 2: Japanese Patent Publication No. 4906424

PTL 3: Japanese Patent Publication No. 4937159

PTL 4: Japanese Patent Publication No. 4880376

PTL 5: Japanese Patent Application Laid-open Publication No. 2002-222227

### SUMMARY OF INVENTION

### Technical Problem

In a non-functional requirement, generally a value or a state to be satisfied is specified from a plurality of candidates based on a degree of social influence of a system. However, in Patent literature 1, as corresponding information of the non-functional requirement, it is defined whether or not the non-functional requirement is relatively improved by processing which can achieve the non-functional requirement, and it is not considered what a type of state the non-functional requirement specifically becomes. Therefore, the value or the state to be satisfied based on the degree of social influence is not specified.

In Patent literature 2, service satisfying a condition is extracted, using a search key which is a value specified as the non-functional requirement, based on a performance value given from registered Web services. This is search similar to keyword match, it is assumed that one Web service is configured by simple combination of each Web service. Therefore, it is not applicable to a case in which various kinds of components are complexly combined, and a system is constructed to satisfy requirements.

In Patent literature 3, it is necessary to prepare a candidate for combination corresponding to a setting value of a requirement for each available product. It is, however, difficult to list all the candidates for combination for many products. Various factors, like a standby configuration of a standby system, a method of data backup, in addition to combination of products affect a non-functional requirement, but is not considered in Patent literature 3.

Patent literatures 4 and 5 disclose the technology which supports design operation by a user. According to the technology, SLO which is affected when design is changed is presented, or when a part of design is determined options are presented by narrowing down candidates of configurations which the others can make up. Therefore the system configuration satisfying SLO specified by a user cannot be derived.

The invention is accomplished by considering the above situation, and a main object of the invention is to provide a design support system, a method, and program which automatically and efficiently derive a candidate for a system configuration satisfying specified non-functional requirements while considering various factors affecting non-functional requirements.

### Solution to Problem

A first design support device according to the present invention includes: reception means for receiving a non-functional requirement; and

constraint condition generating means for generating, in regard to attribute-values for the components of a system designed by combining two or more types of components, a constraint condition for the attribute-values for satisfying the non-functional requirement received by the reception means based on attribute-value condition information that defines a condition required to satisfy the non-functional requirement.

A design support method according to the present invention includes: receiving a non-functional requirement: and

generating, in regard to attribute-values for the components of a system designed by combining two or more types of components, a constraint condition for the attribute-values for satisfying the non-functional requirement received by the reception means based on attribute-value condition information that defines a condition required to satisfy the non-functional requirement.

In addition, the object is also achieved by a computer program that achieves the design support method having each configurations described above with a computer, and a computer-readable recording medium that stores the computer program.

### Advantageous Effects of Invention

According to the present invention, the advantageous effects that a candidate for a system configuration satisfying specified non-functional requirements is automatically and efficiently derived while considering various factors affecting non-functional requirements is obtained.

### BRIEF DESCRIPTION OF DRAWINGS

FIG. 1 a block diagram illustrating a design support device of a first exemplary embodiment of the invention:

FIG. 2A a conceptual diagram illustrating a system model:

FIG. 2B a conceptual diagram illustrating an example of architecture of the system model illustrated in FIG. 2A:

FIG. 3A a diagram illustrating an example of architecture of the system model illustrated in FIG. 2A:

FIG. 3B a diagram illustrating an example of architecture of the system model illustrated in FIG. 2A:

FIG. 4 a diagram illustrating another example of the system model:

FIG. 5A a table illustrating an example of a non-functional requirement:

FIG. 5B a table illustrating an example of a non-functional requirement:

FIG. 6 a table illustrating an example of a non-functional requirement and Attribute-value corresponding information:

FIG. 7 a diagram illustrating an example of a system model:

FIG. 8 a flowchart illustrating a process flow of the design support device of the first exemplary embodiment:

FIG. 9 a block diagram illustrating a design support device of a second exemplary embodiment of the invention:

FIG. 10 a conceptual diagram of a system model template:

FIG. 11A a table illustrating an example of attribute information defined by the system model template:

FIG. 11B a table illustrating an example of attribute information defined by the system model template:

FIG. 12 a flowchart illustrating a process flow of a model search unit:

FIG. 13 a block diagram illustrating a design support device of a third exemplary embodiment of the invention:

FIG. 14 a diagram exemplifying a hardware configuration realizing the design support device of each of the exemplary embodiments of the invention.

### DESCRIPTION OF EMBODIMENTS

### First Exemplary Embodiment

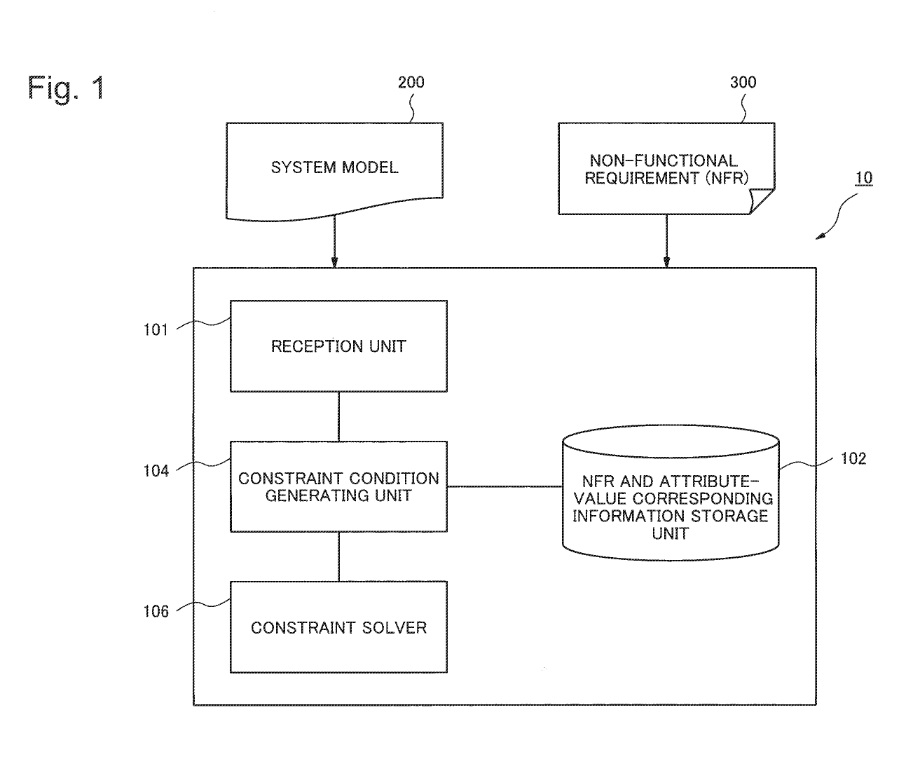

FIG. 1 is a block diagram illustrating a configuration of a design support device 10 of a first exemplary embodiment of the invention. The design support device 10 of the invention is explained below.

The design support device 10 includes a reception unit 101, a NFR (Non-Functional Requirements) and Attribute-value corresponding information storage unit 102, a constraint condition generating unit 104, and a constraint solver 106. The design support device 10 receives a system model 200 and a non-functional requirement 300 at the reception unit 101.

The system model 200 is a schematic model of a design target system, and includes various pieces of design information on the system which is designed by combining two or more than two components. Specifically, the system model 200 includes, as the design information, connection state of factors configuring the system, e.g. hardware, middleware, etc. and information on design parameters which affect system quality. The system model 200 may include, as the design information, information on possible values for the design parameters. The information on the design parameters and the information on the possible values for the design parameters may be defined as attribute-values of system components representing the factors configuring the system (hereinafter, referred to as “component”).

The design support device 10 may include, with respect to attribute-values of the component of the system model 200, a function outputting a combination satisfying the non-functional requirement 300. In the exemplary embodiment, the attribute-values means design information which is necessary for satisfaction of the non-functional requirements.

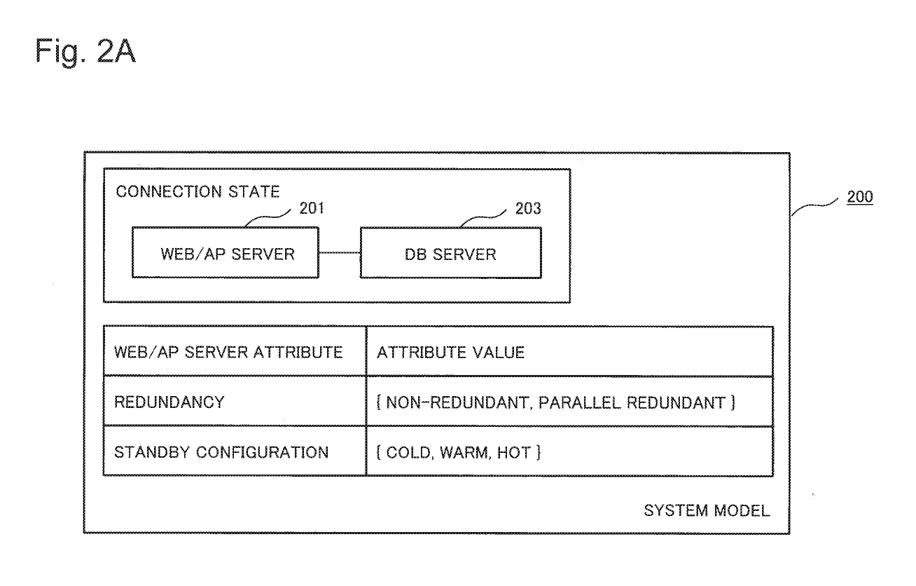

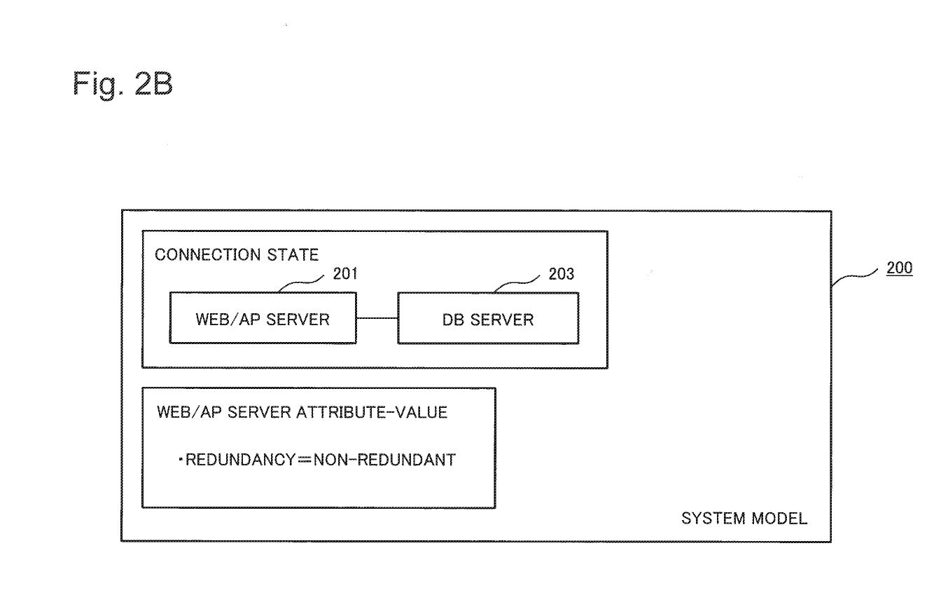

FIG. 2A is a conceptual diagram illustrating a system model 200 of the invention. The system model 200 shown in FIG. 2A includes a connection state in which Web/AP (Application) server 201 and a DB (Database) 203 are combined. “Web/AP server 201” means that any one of a Web server and an AP server is applicable. The Web/AP server 201 includes attributes, i.e. “redundancy” and “standby configuration”. “Redundancy” takes, as attribute values, “non-redundant” and “parallel redundant”. “Standby configuration” takes, as attribute values, “cold” and “warm” or “hot”. By changing the attribute values of the component of the system model 200, a plurality of pieces of architecture whose redundancy configuration is different each other can be expressed. FIG. 2B illustrates the architecture of the system model 200 in which the Web/AP server 201 takes “non-redundant”, as an attribute-value of “redundancy”.

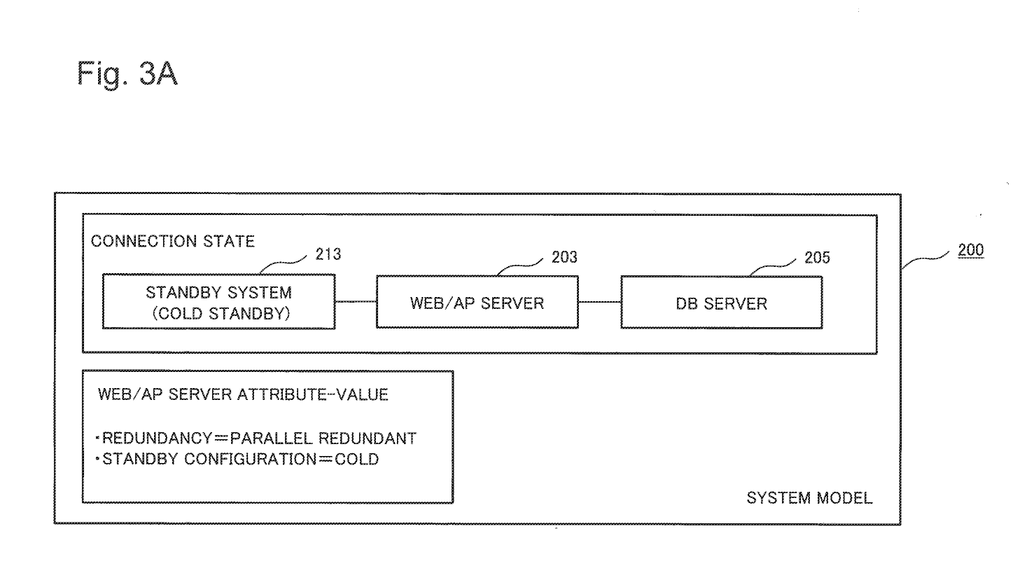

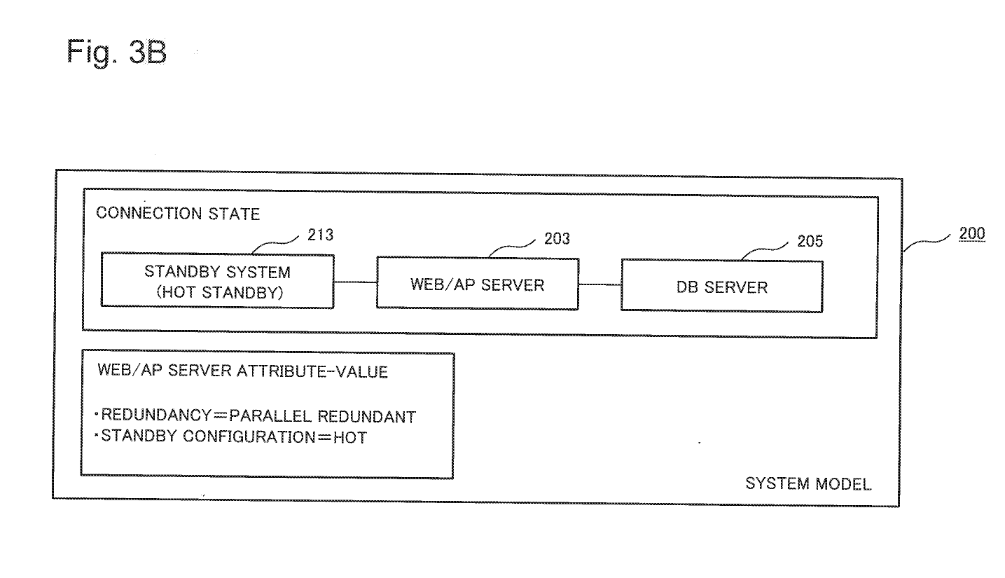

FIG. 3A and FIG. 3B are diagrams illustrating an example of the architecture of the system model 200 in which redundancy of the Web/AP server 201 and attribute-values of the standby configuration are changed in the system model 200 in FIG. 2B. FIG. 3A illustrates a configuration in which redundancy is set to “parallel redundant” and a standby configuration is set to “cold”. FIG. 3B illustrates a configuration in which redundancy is set to “parallel redundant” and a standby configuration is set to “hot”. In this exemplary embodiment, it is explained that architecture satisfying non-functional requirements is calculated by solving a constraint satisfaction problem described below.

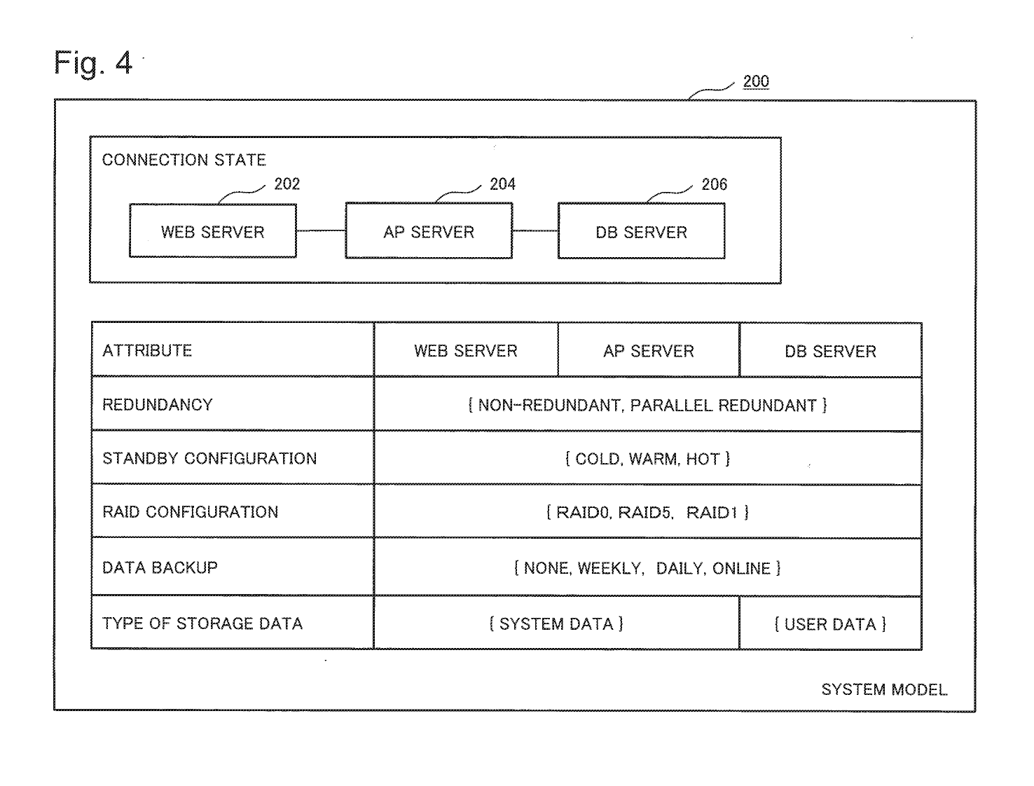

By referring to FIG. 4, the system model 200 of the exemplary embodiment and attribute values are explained. As shown in FIG. 4, the system model 200 includes the configuration in which a Web server 202, an AP server 204, and a DB server 206 are connected in series.

In the system model 200, redundancy, a standby configuration, a RAID (Redundant Arrays of In expensive Disks) configuration, data backup, and a type of storage data are defined as attributes. These attributes are examples, and do not limit this exemplary embodiment.

The Web server 202, the AP server 204, and the DB server 206 take, as attribute values, values described in parentheses which are associated with the attributes shown in FIG. 4. Each server can take, as an attribute value of redundancy, “non-redundant” or “parallel redundant”. Each server can take, as an attribute value of a standby configuration, “cold”, “warm” or “hot”. Each server can take, as an attribute value of a RAID configuration, “RAID0”, “RAID5”, or “RAID1”. Each server can take, as an attribute value of data backup, “none”, “weekly”, “daily”, or “online”. The Web server 202 and the AP server 204 can take, as an attribute value of a type of storage data, “system data”. The DB server 206 can take, as an attribute value of a type of storage data, “user data”. The system model 200 can configure various types of architecture by combining the attribute values above described.

A non-functional requirement is explained below.

The non-functional requirement includes information on a requirement, specified by a client, related to quality of a design target system. Specifically the non-functional requirement may include e.g. information, specified by a client, related to performance or availability of the design target system. The non-functional requirement may include, as a requirement specified by a client, information in which a value or a state to be satisfied is chosen from a plurality of candidates. A specific example of the non-functional requirement is explained below.

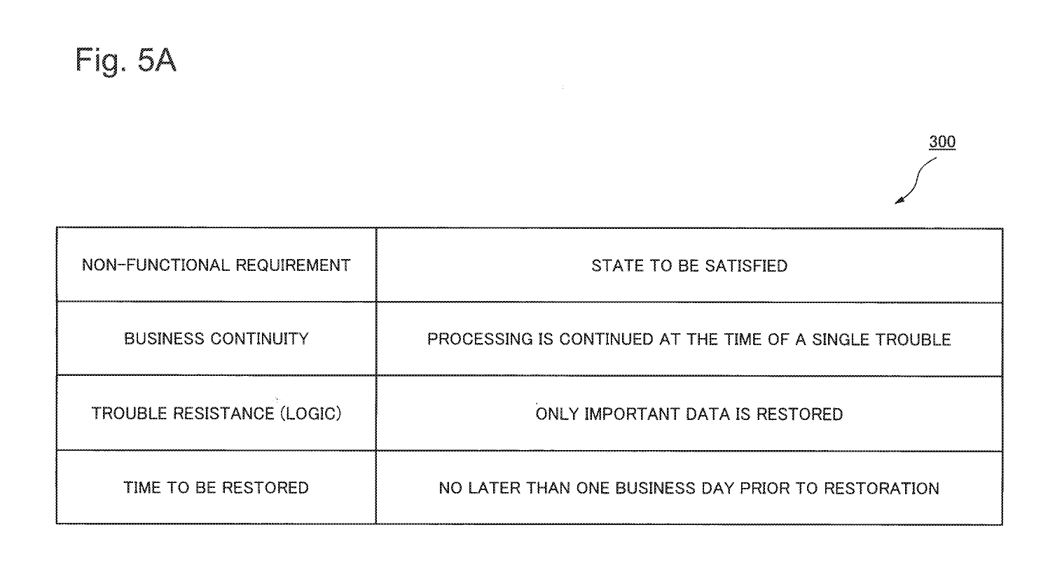

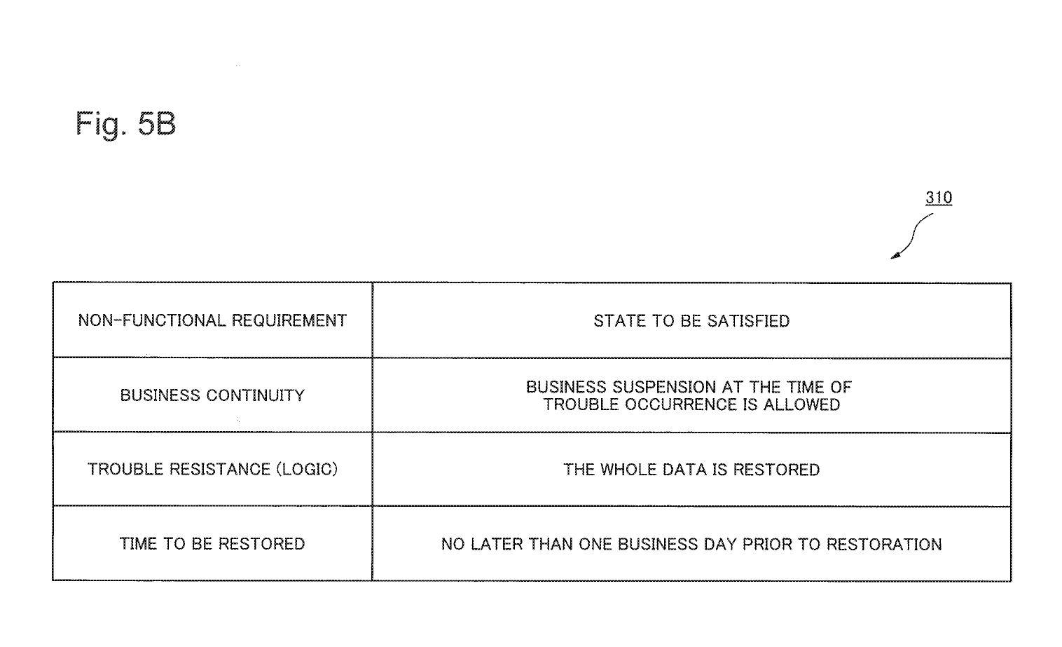

FIG. 5A and FIG. 5B are tables illustrating specific examples of the non-functional requirement (non-functional requirements 300, 310). Referring to FIG. 5A and FIG. 5B, as a non-functional requirement on a system availability, a business continuity, a trouble resistance (logic) (range of data to be restored) and a time to be restored, when the trouble is occurred are specified. These non-functional requirements are examples, and do not limit the exemplary embodiment.

The non-functional requirement 300 shown in FIG. 5A specifies, as the business continuity, “processing is continued at the time of a single trouble”, as the trouble resistance (logic), “only important data is restored”, and, as the time to be restored, “no later than one business day” prior to restoration. The non-functional requirement 310 shown in FIG. 5B specifies, as the business continuity, “business suspension at the time of trouble occurrence is allowed”, as the trouble resistance (logic), “the whole data is restored”, and, as the time to be restored, “no later than one business day” prior to restoration. The non-functional requirement 300 differs from the non-functional requirement 310 in a specified state to be satisfied. The non-functional requirement and the state to be satisfied can be specified in accordance with requirements specified by a client. As the state to be satisfied, the most desired state to be satisfied may be chosen and specified from a plurality of states which each item of the non-functional requirement can take.

The NFR and Attribute-value corresponding information storage unit 102 shown in FIG. 1 stores Non-functional requirement and Attribute-value corresponding information (hereinafter, referred to as “NFR and Attribute-value corresponding information”) which is information which is required for satisfying non-functional requirements and defines conditions for attribute values of a component of a system model. The NFR and Attribute-value corresponding information is explained below.

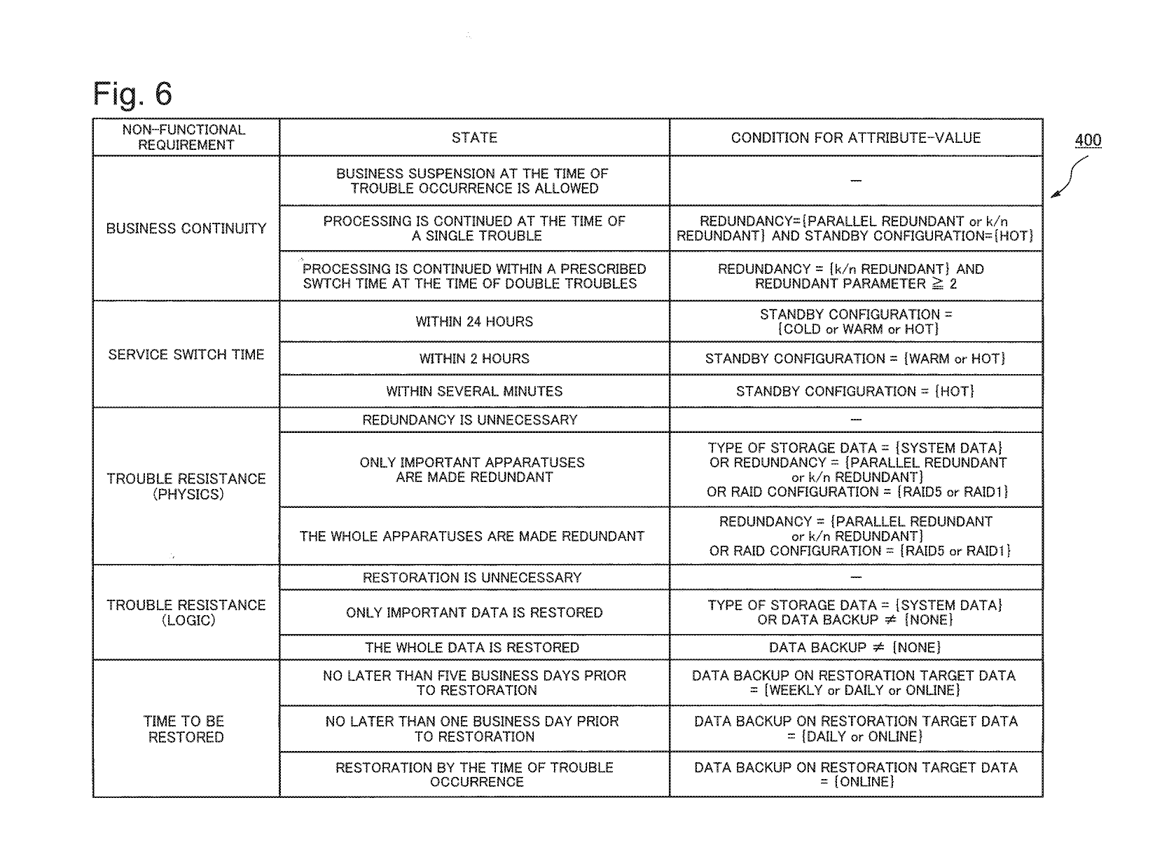

FIG. 6 is a table illustrating an example of NFR and Attribute-value corresponding information 400. The NFR and Attribute-value corresponding information 400 defines conditions for attribute-values on five items of the non-functional requirement which are the business continuity, the service switch time, the trouble resistance (physics), the trouble resistance (logic), and the time to be restored. The NFR and Attribute-value corresponding information 400 may define the conditions for the attribute values by each associating with a plurality of states which each non-functional requirement can take. The conditions may be described as a form of a logical formula.

The constraint condition generating unit 104 shown in FIG. 1 generates a constraint condition to an attribute value of each component of a system model based on, for example, a non-fundamental requirement which the reception unit 101 receives from the outside and the NFR and Attribute-value corresponding information 400. The constraint condition generating unit 104 formulates the generated constraint condition as the constraint satisfaction problem.

The constraint condition generating unit 104 extracts the constraint condition from the NFR and Attribute-value corresponding information 400 shown in FIG. 6, for example, when the non-functional requirement 300 shown in FIG. 5A is received in the system model 200 shown in FIG. 4. The constraint condition generating unit 104 extracts the condition, “redundancy=(parallel redundant or k/n (k-out-of-n system) redundant) AND standby configuration=(hot)” which is required for the state of business continuity to satisfy “processing is continued at the time of a single trouble”. The extracted condition is given to each component as a constraint condition of an attribute value of each component (Web server 202, AP server 204, DB server 206).

The constraint condition generating unit 104 also extracts the condition, “type of storage data=(system data) OR data backup≠(none)” which is required for the state of trouble resistance (logic) to satisfy “only important data is restored”. The extracted condition is given to each component as a constraint condition of an attribute value of each component (Web server 202, AP server 204, DB server 206).

In the system model 200 shown in FIG. 4, a type of data stored in the Web server 202 and the AP server 204 is “system data”, and a type of data stored in the DB server 206 is “user data” which is a fixed value. Since the Web server 202 and the AP server 204 necessarily satisfy the condition, “type of storage data=(system data)”, it is unnecessary to consider the other constraint conditions.

In the DB server 206, since the above condition is not satisfied, the condition, “data backup≠(none)” is given to the DB server 206, as the constraint condition for the attribute value. This represents that the constraint condition, “data backup≠(none)” is given to only data backup attribute of the DB server, since it is necessary to restore only a type of data which is user data, as a state which trouble resistance (logic) has to satisfy.

Regarding the DB server 206 having restoration target data (user data), the constraint condition generating unit 104 extracts the condition, “data backup={daily or online}” which is required for a state of the time to be restored to satisfy “no later than one business day prior to restoration”, and gives it to the DB server 206 as the constraint condition for the attribute value.

The constraint condition generating unit 104 formulates the constraint condition given to each server as the constraint satisfaction problem.

The constraint solver 106 includes a function of solving the constraint satisfaction problem on an attribute value of a component of a system model generated by the constraint condition generating unit 104 by using an existing general-purpose method, for example, back tracking. It does not limit a method solving the constraint satisfaction problem and the constraint solver 106 may include a function of solving the constraint satisfaction problem by using another method. A flow of solving the constraint satisfaction problem on the attribute value of the component of the system model is explained below.

The constraint solver 106 defines a set of variables and a region of each variable based on attributes of components of the system model 200 shown in FIG. 4 and values which they can take (attribute values). In order to simplifying explanations, a value which each attribute value can take is defined by replacing into an integer of not less than zero in order.
{non-redundant, parallel redundant}={0, 1}
{cold, warm, hot}={0, 1, 2}
{RAID0, RAID5, RAID 1}={0, 1, 2}
{none, weekly, daily, online}={0, 1, 2, 3}
{system data}={0}, {user data}={1}

Definition of attribute values are not limited to above descriptions, definitions different from the above definition are applicable.

By defining the attribute values as above descriptions, the set of variables and the region of each variable are described below.
Redundancy: x_web, x_ap, x_db={0, 1}
Standby configuration: y_web, y_ap, y_db={0, 1, 2}
RAID configuration: z_web, z_ap, z_db={0, 1, 2}
Data backup: u_web, u_ap, u_db={0, 1, 2, 3}
Type of storage data: w_web, w_ap={0}, w_db={1}
   where, x, y, z, u and w are valuables, x representing the redundancy, y representing the standby configuration, z representing the RAID configuration, u representing the data backup and w representing the type of storage data. Subscript “web” is a variable on an attribute of Web server, “ap” is a variable on an attribute of AP server, and “db” is a variable on an attribute of DB server.

A set of constraints between variables is defined below, based on the non-functional requirement 300 shown in FIG. 5A and the NFR and Attribute-value corresponding information 400 shown in FIG. 6. The state in which redundancy is k/n redundant is replaced into x=2.
((x_web=1) [symbol] (x_web=2)) [symbol] (y_web=2)
((x_ap=1) [symbol] (x_ap=2)) [symbol] (y_ap=2)
((x_db=1) [symbol] (x_db=2)) [symbol] (y_db=2)
(w_web=0) [symbol] (u_web≠0)
(w_ap=0) [symbol] (u_ap≠0)
(w_db=0) [symbol] (u_db≠0)
(w_db=1) [symbol] (w_db=2)
   where “ [symbol] ” is OR, “ [symbol] ” is AND.

The constraint solver 106 can obtain a value of a variable by solving the constraint satisfaction problem. The value of the variable is obtained as follows.

### <Solution 1>

x_web=x_ap=x_db=1
y_web=y_ap=y_db=2
u_db=1

### <Solution 2>

x_web=x_ap=x_db=1
y_web=y_ap=y_db=2
u_db=2
   Variables other than above descriptions can take an optional value in each region.

Therefore, as a combination of attribute values which satisfy the non-functional requirement shown in FIG. 5A, following two solutions are derived.

### <Solution 1>

Web server: redundancy=(parallel redundant), Standby configuration=(hot)
AP server: redundancy=(parallel redundant), Standby configuration=(hot)
DB server: redundancy=(parallel redundant), Standby configuration=(hot), data backup=(daily)

### <Solution 2>

Web server: redundancy=(parallel redundant), Standby configuration=(hot)
AP server: redundancy=(parallel redundant), Standby configuration=(hot)
DB server: redundancy=(parallel redundant), Standby configuration=(hot), data backup=(online)

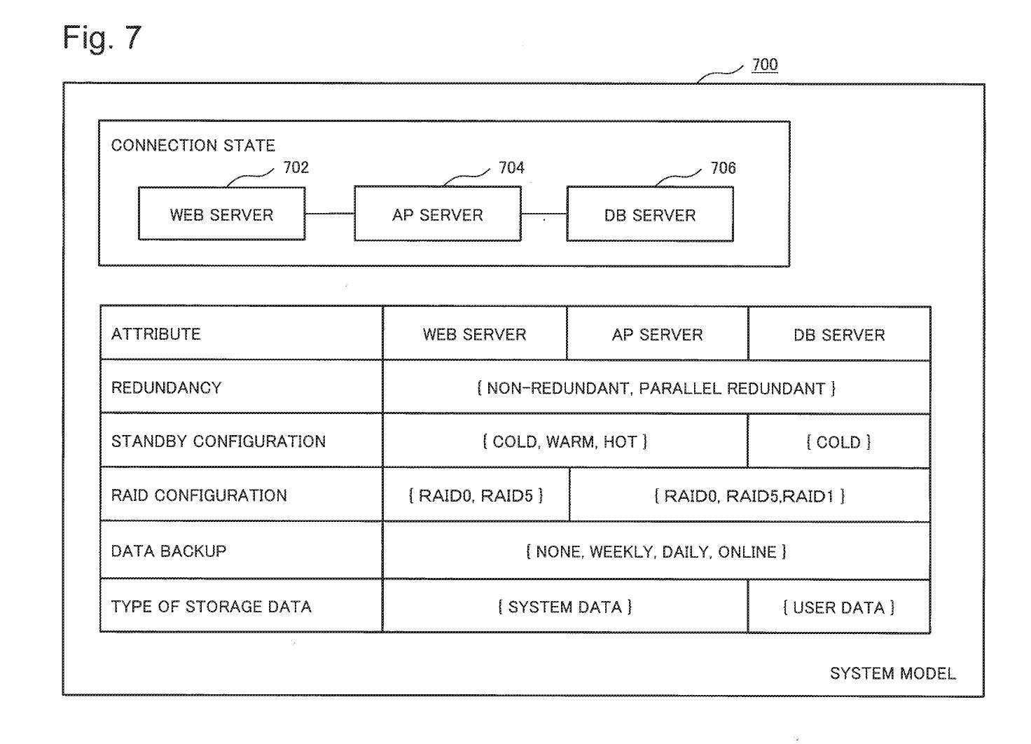

An value which an attribute of a component can take may be different for each system model. A system model 700 shown in FIG. 7 is explained, as an example. In the system model 700, a connection state of the server is identical with that of the system model 200, however an attribute value which the server can take is different from that of the system model 200. Specifically, in the system model 700, a DB server 706 takes only cold as the standby configuration, and a Web server 702 takes RAID0 or RAID5 as the RAID configuration.

The constraint condition generating unit 104 extracts a condition for satisfying “processing is continued at the time of a single trouble” which is a state of business continuity defined by the NFR and Attribute-value corresponding information 400, when the non-functional requirement 300 shown in FIG. 5A is given to the system model 700. The constraint condition generating unit 104 extracts the condition, “redundancy=(parallel redundant or k/n redundant) AND standby configuration=(hot)”, and gives the extracted condition, as a constraint condition for an attribute value, to each component. However, since the DB server 706 takes only “cold” as the standby configuration, a solution which satisfies the constraint condition, “standby configuration=(hot)” does not exist. Therefore, “processing is continued at the time of a single trouble” cannot be realized in the system model 700.

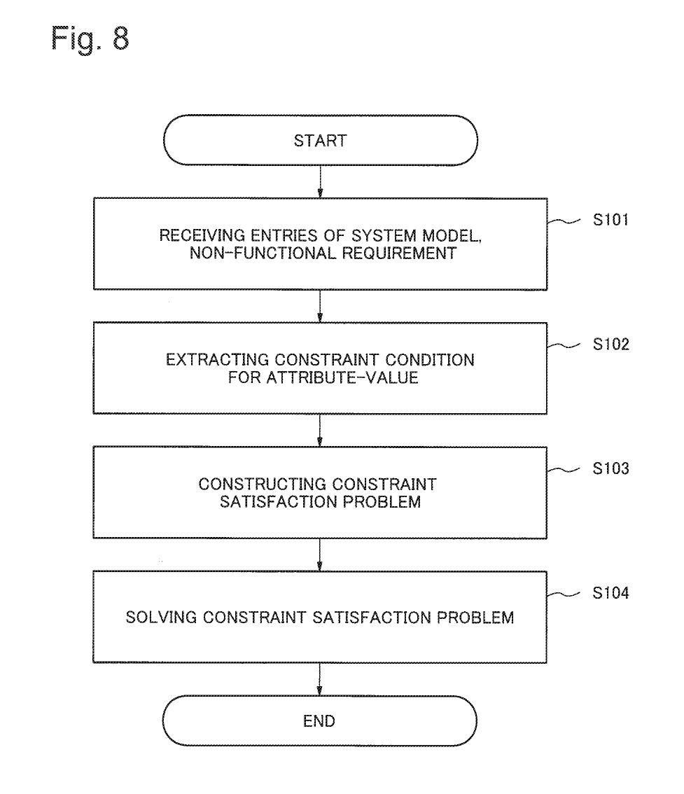

FIG. 8 is a flowchart illustrating a process flow of the design support device 10 of the exemplary embodiment. The process flow of the design support device 10 is described below in detail.

The design support device 10 receives entries of a system model on a design target system and a non-functional requirement from a user (not shown), an outer device, or the like (step S101).

Next the constraint condition generating unit 104 extracts a constraint condition for an attribute value of a component of the system model required for satisfying the non-functional requirement by referring to the NFR and Attribute-value corresponding information (step S102).

The constraint condition generating unit 104 constructs (formulate) a constraint satisfaction problem on the attribute value based on the constraint condition on the extracted attribute value (step S103).

The constraint solver 106 solves the constraint satisfaction problem by using a general-purpose method, for example, back tracking, and calculates a candidate of a combination of the attribute values of the component of the system model satisfying the non-functional requirement (step S104).

As mentioned above, the design support device 10 of the exemplary embodiment has an advantageous effect that a candidate of a system configuration (system architecture) satisfying a specified non-functional requirement is automatically and efficiently derived while considering various factors which affect the non-functional requirement. Since the candidate of the system configuration is automatically and efficiently derived, an advantageous effect that load of a system designer can be reduced is obtained.

The design support device 10 has an advantageous effect in which a value and a state to be satisfied can be specified, as a non-functional requirement, from a plurality of candidates based on social influence of a design target system by defining the NFR and Attribute-value corresponding information associating a plurality of states of the non-functional requirement with conditions for attribute values.

### Second Exemplary Embodiment

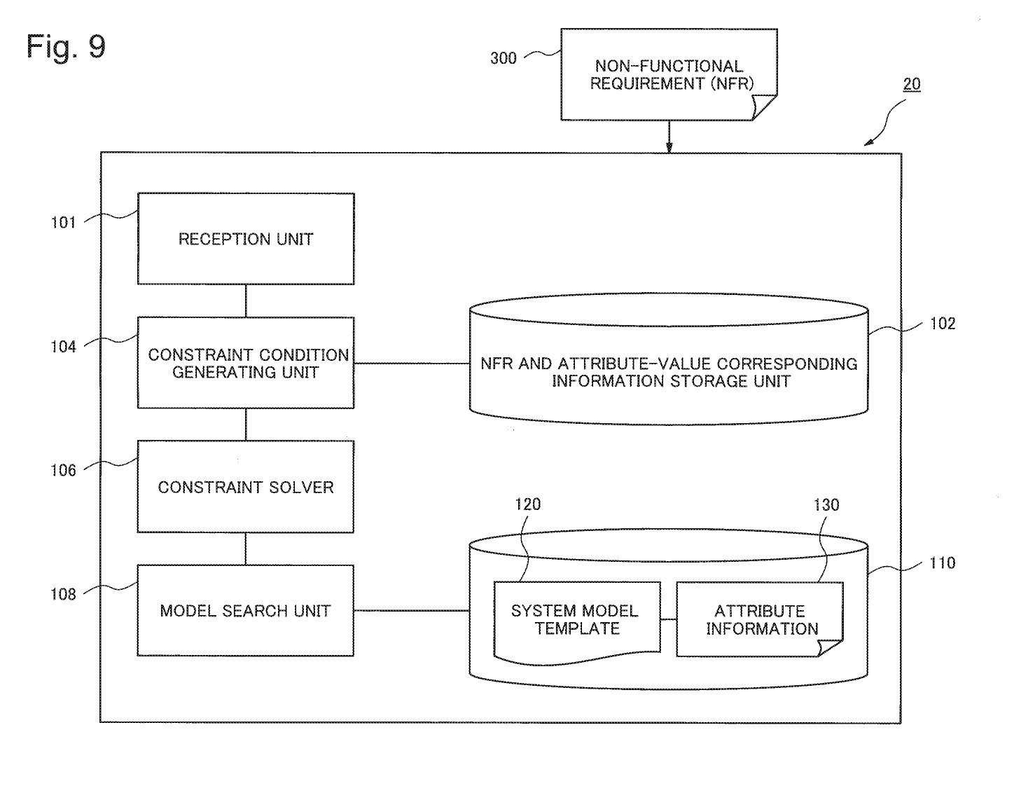

FIG. 9 is a block diagram illustrating a configuration of a design support device 20 of a second exemplary embodiment of the invention. The design support device 20 is explained below.

Referring to FIG. 9, the design support device 20 includes the reception unit 101, the NFR and Attribute-value corresponding information storage unit 102, the constraint condition generating unit 104, the constraint solver 106, a model search unit 108, and a model storage unit 110. The design support device 20 differs from the design support device 10 of the first exemplary embodiment in having the model search unit 108 and the model storage unit 110. A system model is not entered in the design support device 20, but only non-functional requirement is entered therein and received by the reception unit 101. The design support device 20 has a function of outputting a system model template with an attribute information according with a combination of attribute values which satisfy the non-functional requirement, and corresponding attribute information.

The model storage unit 110 stores a system model template 120 and attribute information 130 corresponding to the system model template 120. The model storage unit 110 may store a plurality of system model templates 120 and a plurality of pieces of attribute information 130 corresponding to respective system model templates 120.

The system model template 120 in the model storage unit 110 includes information corresponding to a model of system design information. Specifically, the system model template 120 includes information on a component describing elements configuring the system (e.g. hardware, middleware, etc.) in units of functions, and information on a connection state of the components. The system model template 120 may include information in which a common part is extracted from design information corresponding to a type or function of service provided by the system, and may include information on a type of an attribute which can be defined with respect to the component.

The attribute information 130 in the model storage unit 110 includes information representing an attribute value of each component of the system model template 120. A plurality of pieces of the attribute information 130 may be defined with respect to the system model template 120. The attribute information 130 may include information which defines a different part for each system, except the common part extracted from the system design information as the system model template 120.

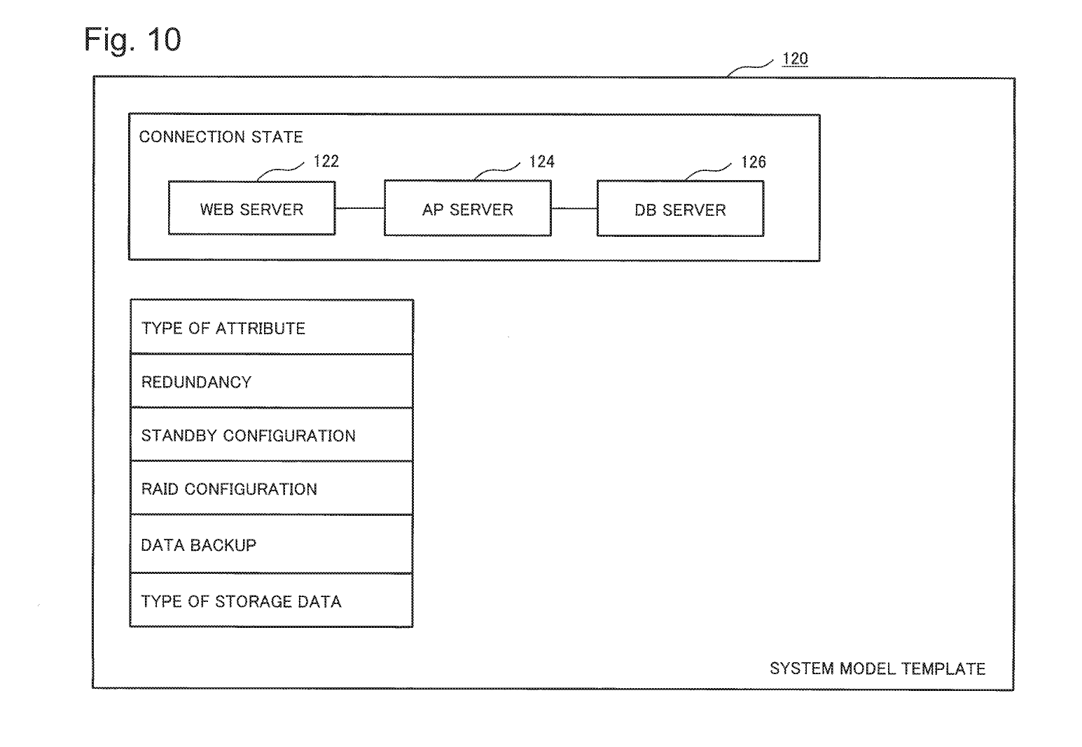

An example of the system model template 120 representing a general Web three-layer system is illustrated in FIG. 10. Referring to FIG. 10, the system model template 120 includes a Web server 122, an AP server 124, and DB server 126.

The system model template 120 includes a type of attributes which is defined with respect to a component. The defined attributes are redundancy, a standby configuration, a RAID configuration, data backup, a type of storage data, or the like. The system model template 120 shown in FIG. 10 is an example, and does not limit the exemplary embodiment.

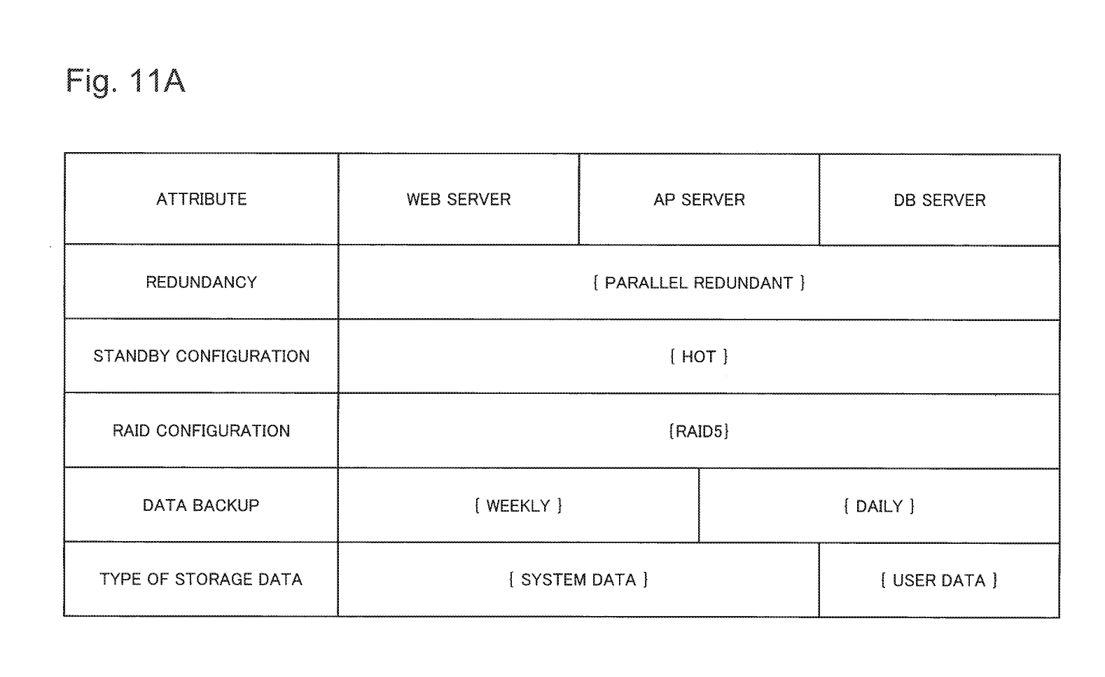

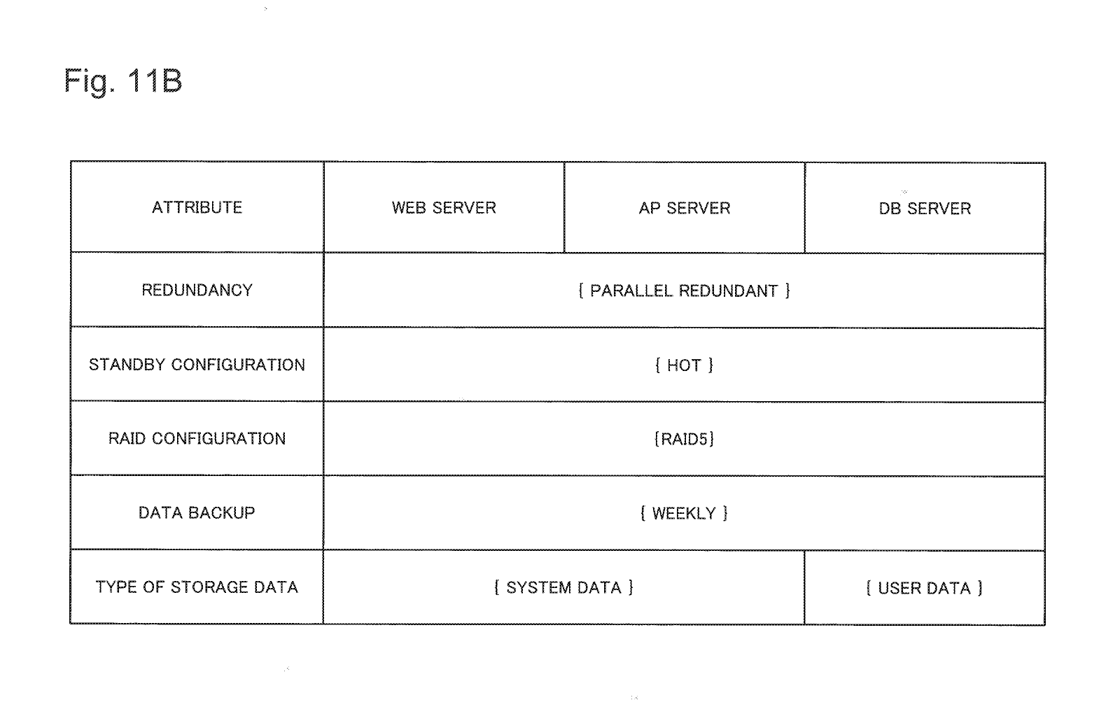

FIG. 11A and FIG. 11B illustrate examples of the attribute information 130 defined with respect to the system model template 120 shown in FIG. 10. FIG. 11A differs from FIG. 11B in a value of an attribute of the DB server, “data backup”. In the table in FIG. 11A, regarding the attribute “data backup”, the Web server takes “weekly”, the DB server takes “daily”, and the AP server takes “weekly” or “daily”, as the attribute information. In the table in FIG. 11B, each of the Web server, The DB server, and the AP server take “weekly”, as the attribute information. As described above, different attribute information can be expressed based on the common system model template.

The constraint condition generating unit 104 of the second exemplary embodiment generates a constraint condition for attribute value which can be defined with respect to the component of the system model template 120 based on the non-functional requirement 300 which the reception unit 101 receives from the outside and the NFR and

Attribute-value corresponding information 400. The constraint condition generating unit 104 formulates the constraint satisfaction problem based on the constraint condition.

The constraint solver 106 solves the constraint satisfaction problem on the attribute values of the system model template generated by the constraint condition generating unit 104 by using an existing general-purpose method, for example, back tracking, like the first exemplary embodiment. Thereby a combination of attribute values which satisfies the non-functional requirement (solution) is derived.

The model search unit 108 searches the attribute information 130 included in the combination of attribute values (solution) derived by the constraint solver 106 in the attribute information 130 corresponding to each system model template 120 stored in the model storage unit 110. For example, if the non-functional requirements shown in FIG. 5A is given, regarding the system model templates shown in FIG. 11A and FIG. 11B and corresponding attribute information, FIG. 11A is included in the solution derived by the constraint solver 106, and FIG. 11B is not included therein.

The model search unit 108 may have a function of calculating a degree of recommendation for ranking attribute information and rearranging the attribute information based on the degree of recommendation. Specifically, the model search unit 108 calculates, for example, a system price, as a degree of recommendation. In this case, the model search unit 108 can rearrange the attribute information in the order of low price. The model search unit 108 calculates, for example, an evaluation value indicating system quality, as the degree of recommendation. In this case, the model search unit 108 can rearrange the attribute information in the order of high evaluation value.

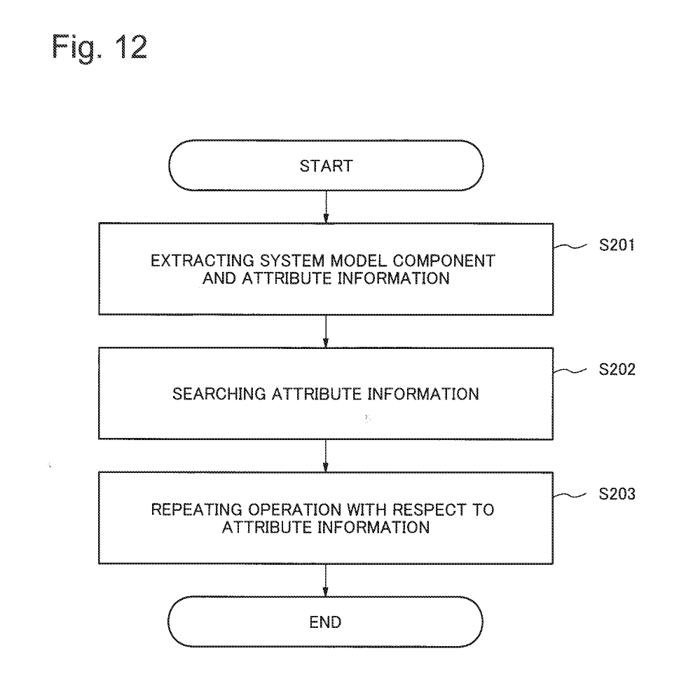

FIG. 12 is a flowchart illustrating a process flow of the model search unit 108. Referring to FIG. 12, operations of the model search unit 108 are explained.

The model search unit 108 extracts the system model template 120 and the corresponding attribute information 130 from the model storage unit 110 (step S201).

It is searched whether or not a solution which corresponds to the attribute information extracted in step S201 is included in the combination of a plurality of attribute values (solution) which satisfies a non-functional requirement specified from the outside and is derived by the constraint solver 106 (step S202).

Operations of step S201 and step S202 are repeated with respect to the system model template 120 and the corresponding attribute information 130 included in the model storage unit 110 (step S203).

The design support device 20 may further include a device which outputs the attribute information 130 which is determined to correspond to a candidate of the solution with corresponding system model template 120 toward the outside.

As described above, in the exemplary embodiment, the design support device 20 associates a system model template including information corresponding to a model of system design information with attribute information representing an attribute value of each component of the system model template, and stores them in the model storage unit 110. The model search unit 108 searches whether or not a combination which corresponds to the attribute information stored in the model storage unit 110 is included in combinations of a plurality of attribute values (solution) derived by the constraint solver 106, and outputs the search result. In the exemplary embodiment, based on the above configuration, since a plurality of pieces of different design information which satisfy specified non-functional requirements are presented to a user, the user can design the system while comparing them.

### Third Exemplary Embodiment

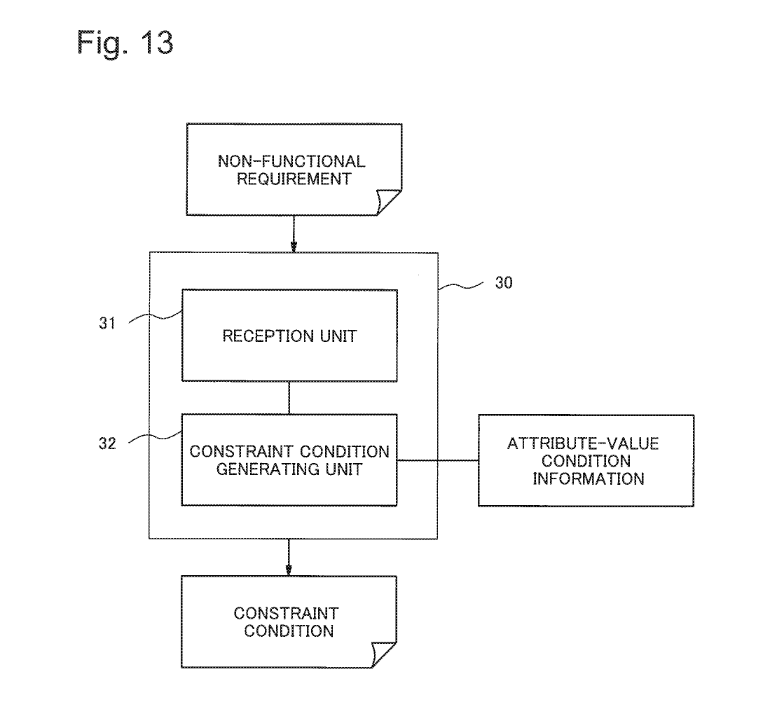

FIG. 13 is a block diagram illustrating a design support device 30 of a third exemplary embodiment. Referring to FIG. 13, the design support device 30 of the third exemplary embodiment is explained.

Referring to FIG. 13, the design support device 30 includes a reception unit 31 and a constraint condition generating unit 32. The reception unit 31 receives a non-functional requirement. The constraint condition generating unit 32 generates, in regard to attribute values for the components of a system designed by combining two or more types of components, a constraint condition for the attribute values for satisfying the received non-functional requirement based on attribute-value condition information that defines a condition required to satisfy the non-functional requirement. The attribute value condition information corresponds to the non-functional requirement-attribute value corresponding information in the first exemplary embodiment.

In the third exemplary embodiment, by employing the above configuration, an advantageous effect is obtained in which a candidate of a system configuration which satisfies a specified non-functional requirement can be automatically and efficiently derived while considering various factors which affect the non-functional requirement.

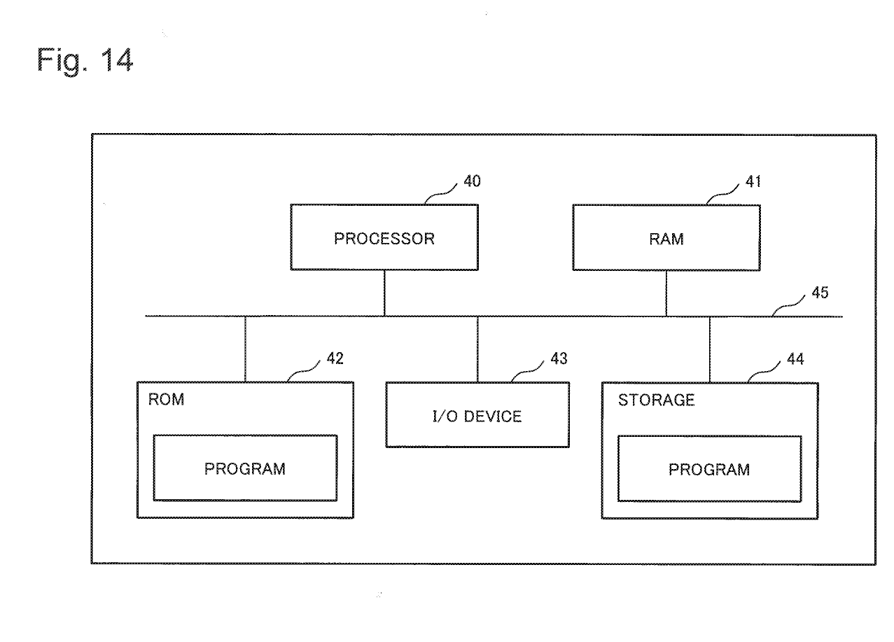

Respective parts of the design support device shown in FIG. 1, etc. are realized by hardware resources exemplified in FIG. 14. The configuration in FIG. 14 includes a processor 40, a RAM (Random Access Memory) 41, a ROM (Read Only Memory), 42, an I/O (Input/Output) device 43, a storage 44, and a bus 45 connecting the respective elements.

In the exemplary embodiments described above, as an example executed by the processor 40 shown in FIG. 14, the following case has been explained. The exemplary embodiments are achieved when the processor 40 reads a computer program into the RAM 41 and execute the computer program, after the computer program which can achieve the above function is supplied to the design support device. A part or all of the functions shown in respective blocks shown in FIG. 1 and the like may be realized as hardware.

The supplied computer program may be stored in readable/writable memory (temporary storage medium) or a computer-readable storage device, like a hard disc device. In such case, it is understood that the invention is configured by codes representing the computer program or a storage medium storing the computer program.

Although the invention is described by referring to the exemplary embodiments, the invention is not limited to the above mentioned exemplary embodiments. It is to be understood that to the configurations and details of the invention, various changes can be made within the scope of the invention.

A part or all of the above exemplary embodiment may be described as follows. The following supplementary notes do not limit the invention.

[Supplementary Note 1]

A design support device, including:

a constraint condition generating unit that receives a non-functional requirement and generates, based on non-functional requirement-attribute value corresponding information associating the non-functional requirement with an attribute value which is an element of system design information, a constraint condition for the attribute value for realizing the non-functional requirement.

[Supplementary Note 2]

The design support device according to Supplementary note 1, wherein the constraint condition generating unit formulates a constraint satisfaction problem based on the constraint condition.

[Supplementary Note 3]

The design support device according to Supplementary note 2, further including:

a constraint solver that derives the attribute values satisfying the non-functional requirement by solving the constraint satisfaction problem.

[Supplementary Note 4]

The design support device according to Supplementary note 3, further including:

a model storage unit storing the design information and attribute information corresponding to the design information: and

a model search unit comparing the attribute value derived by the constraint solver with the attribute information stored in the model storage unit.

[Supplementary Note 5]

The design support device according to Supplementary note 4, wherein the model search unit calculates a degree of recommendation for ranking the attribute information and rearranges the attribute information based on the degree of recommendation.

[Supplementary Note 6]

The design support device according to Supplementary note 4 or 5, wherein the model storage unit stores the design information corresponding to a plurality of pieces of the attribute information.

[Supplementary Note 7]

The design support device according to any one of Supplementary note 1 to 6, wherein the non-functional requirement and attribute value corresponding information includes information in which the constraint condition is associated with the non-functional requirement having a plurality of different states.

[Supplementary Note 8]

A design support method, including:

receiving a non-functional requirement and generating, based on non-functional requirement-attribute value corresponding information associating the non-functional requirement with an attribute value which is an element of system design information, a constraint condition for the attribute value for realizing the non-functional requirement.

[Supplementary Note 9]

A design support program for causing a computer to execute: receiving a non-functional requirement and generating, based on non-functional requirement-attribute value corresponding information associating the non-functional requirement with an attribute value which is an element of system design information, a constraint condition for the attribute value for realizing the non-functional requirement.

This application is based upon and claims the benefit of priority from Japanese Patent Application No. 2014-089098 filed on Apr. 23, 2014, the entire disclosure of which is incorporated herein.

### INDUSTRIAL APPLICABILITY

The invention is applicable to, for example, a design support device for system architecture.

### REFERENCE SIGNS LIST

10, 20, 30 design support device
102 NFR and Attribute-value corresponding information storage unit
104 constraint condition generating unit
106 constraint solver
108 model search unit
110 model storage unit
120 system model template
122 Web server
124 AP server
126 DB server
130 attribute information
200 system model
202 Web server
204 AP server
206 DB server
300 non-functional requirement
310 non-functional requirement
400 NFR and Attribute-value corresponding information
700 system model
702 Web server
704 AP server
706 DB server

What is claimed is:

1. A design support device, comprising:
one or more processors acting as reception unit configured to receive a non-functional requirement; and
the one or more processors acting as constraint condition generating unit configured to generate, in regard to attribute values for the components of a system designed by combining two or more types of components, a constraint condition for the attribute values for satisfying the non-functional requirement received by the reception unit based on attribute-value condition information that defines a condition required to satisfy the non-functional requirement.

2. The design support device according to claim 1, wherein the constraint condition generating unit formulates a constraint satisfaction problem based on the constraint condition.

3. The design support device according to claim 2, further comprising:
a constraint solver that derives the attribute values satisfying the non-functional requirement by solving the constraint satisfaction problem.

4. The design support device according to claim 3, further comprising:
model storage for storing unit configured to store design information of the system and attribute information corresponding to the design information; and
model search unit configured to search the attribute information satisfying the non-functional requirement received by the reception unit based on a result of comparison between the attribute values derived by the constraint solver and the attribute information stored by the model storage unit.

5. The design support device according to claim 4, wherein the model search unit calculates a degree of recommendation that ranks the attribute information, and presents the attribute information based on the degree of recommendation.

6. The design support device according to claim 4, wherein the model storage unit stores the design information corresponding to a plurality of pieces of the attribute information.

7. The design support device of according to claim 1, wherein the attribute-value condition information includes information in which a plurality of states of the non-functional requirement correspond to the condition for the attribute values required to satisfy a state of each of the non-functional requirement.

8. A design support method, comprising:
receiving a non-functional requirement: and
generating, in regard to attribute values for the components of a system designed by combining two or more types of components, a constraint condition for the attribute values for satisfying the received non-functional requirement based on attribute-value condition information that defines a condition required to satisfy the non-functional requirement.

9. A non-transitory computer-readable recording medium storing a design support program for causing a computer to execute:
a process to receive a non-functional requirement: and
a process to generate, in regard to attribute values for the components of a system designed by combining two or more types of components, a constraint condition for the attribute values for satisfying the received non-functional requirement based on attribute-value condition information that defines a condition required to satisfy the non-functional requirement.
